(19) United States
(12) Patent Application Publication
(10) Pub. No.: US 2013/0245367 A1
(43) Pub. Date: Sep. 19, 2013

(54) Bite Block Gag

(71) Applicant: Joel Tucker, Los Angeles, CA (US)

(72) Inventor: Joel Tucker, Los Angeles, CA (US)

(21) Appl. No.: 13/825,499

(22) PCT Filed: Sep. 21, 2011
(86) PCT No.: PCT/US2011/052600

§ 371 Date: May 28, 2013

Related U.S. Application Data
(60) Provisional application No. 61/385,440, filed on Sep. 22, 2010.

(51) Int. Cl. A61H 19/00

(52) U.S. Cl. CPC A61H 19/00
USPC 600/38

(57) ABSTRACT

A novelty mouth gag providing unobstructed access to the wearer's mouth is disclosed. The gag comprises a left bite block adapted to be inserted between and worn on the wearer's left molars, and, separately, a right bite block adapted to be inserted between and worn on the wearer's right to molars. A head strap arrangement is at least indirectly connected to the left and right bite blocks.

The gag further includes, respectively, left and-right J-straps. Each strap is interconnected between a bite block and the head strap arrangement to urge the connected bite block rearwardly into the wearer's mouth as the head strap arrangement is secured and tightened around the rear of the wearer's head.

Mouth gags are toys commonly used in the fetish, bondage, and adult novelty communities both for their functional use and their aesthetic appeal. While the most common types of gags on the market today are ball gags, other available styles include bit gags, ring gags, mouth hooks, and dental retractor gags. Functionally, the gags are usually used either to obstruct or create access to the mouth of the wearer.

The Bite Block Gag or Wedge Gag embodying the present invention retains the wearer's mouth in an open configuration with minimal gear occupying space inside the wearer's mouth. It is dentally sound; i.e., it is safe for the wearer's teeth and mouth interior. In appearance, it is less intimidating than other gags. It is profoundly functional and minimally intrusive.

### BRIEF DESCRIPTION OF THE DRAWINGS

FIG. 1 is an isometric view showing the embodiment of the preferred embodiment of the invention.

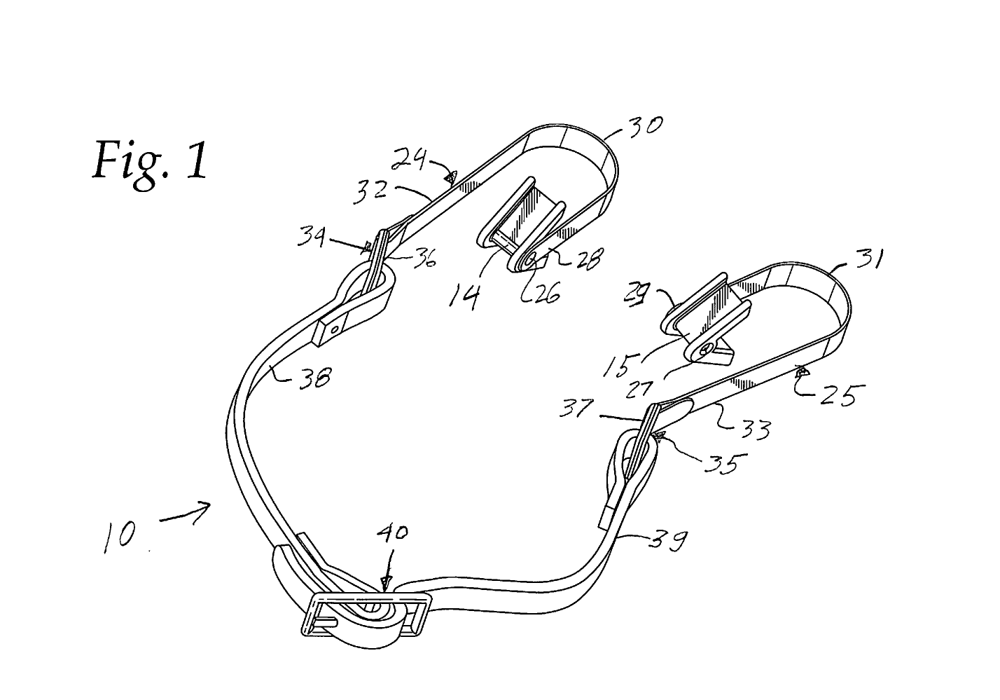

FIG. 2 is an isometric view showing the invention as it appears when it is being worn by a user.

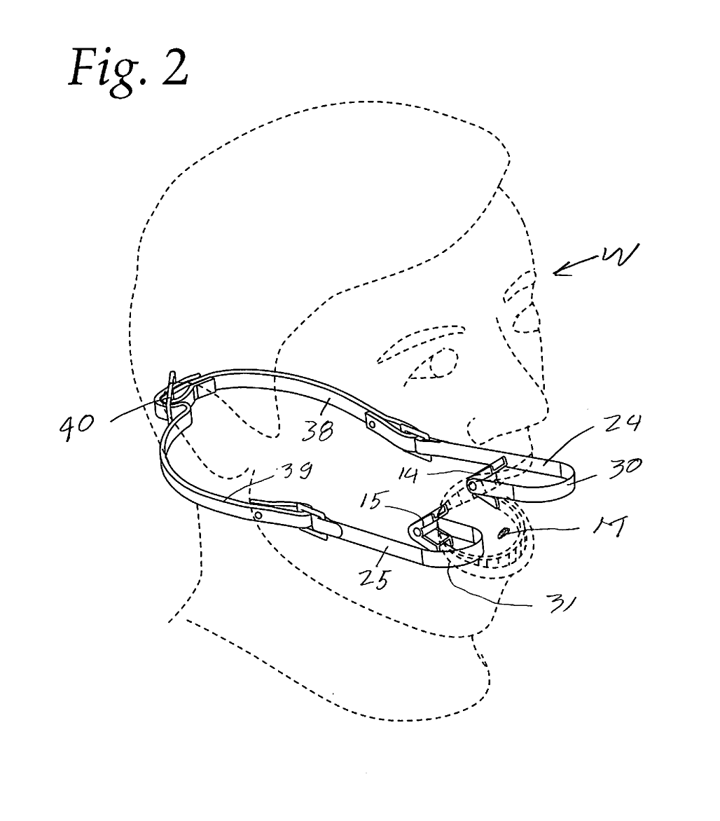

### DETAILED DESCRIPTION

While the invention will be described in connection with a preferred embodiment, it will be understood that it is not intended to limit the invention to this embodiment. On the contrary, it is intended to cover all alternatives, modifications and equivalents as may be included within the spirit and scope of the invention.

In accordance with the invention, the illustrated embodiment of the novel mouth gag 10 provides unobstructed access to the mouth of the wearer W. The gag 10 comprises a left bite block 14 adapted to be inserted between and worn on the wearer's left molars. A separate right bite block 15 is adapted to be inserted between and worn on the wearer's right molars. Left and right J-straps 24 and 25, respectively are connected, as by pivots 26 and 27 to distal ends 28 and 29 of the J-straps 24, 25.

The bite block pivot connectors can be can take the form of a jiffy rivet, bolt, or other known fastening device. The J-straps each comprise U-shaped formations 30 and 31 which are here integral with longitudinal extensions 32 and 33 sized and shaped to extend past the wearer's cheeks to buckle connections 34 and 35. Interconnectors 36 and 37 are secured to straps 38 and 39 which are sized and shaped to interengage at a buckle 40 or other known attachment and adjustment device which is to be located behind the wearer's head. The buckle 40 can permit adjustment of the straps 38, 39 to provide a comfortable or other appropriate gag fit in the wearer's mouth.

Bite blocks 14, 15 are commercially available V shaped wedges adapted to be positioned on the wearer's rear molars so as to prop the wearer's mouth open. These blocks may be made of a polymer material, plastic, fiberglass, neoprene, silicone rubber or natural rubber. Latex free materials are preferred. If desired, brass or other rigid cores can be covered with relatively pliable polycarbonate material to provide a comfortable yet secure and long-lasting gag device.

The J-straps or bars 24 and 25 connect the bite blocks 14, 15 to the head straps 38, 39. The straps 24, 25 illustrated here are generally J-shaped, but rectilinear shapes may be provided if desired. The straps may be made of metal, plastic or other appropriate hygienic material. The straps are sized and shaped so as to attached to the respective bite blocks 14, 15 and to locate the bite blocks 14, 15 at appropriate positions within the wearer' mouth M. The bars then extend out of the wearer's mouth, curve around the corners of the mouth, and attach to the head straps outside of the mouth, preferably at the rear of the wearer's head. The straps are preferably sized and shaped to avoid inordinate chafing, pain or injury to the wearer's cheeks. When these J-straps 24, 25 are sized, shaped and configured as indicated here and each strap is interconnected between a bite block and the head strap arrangement, the J-straps 24, 25 each urge the connected bite block 14, 15 rearwardly into the wearer's mouth as the head strap arrangement 38, 39, 40 is secured and tightened around the rear of the wearer's head.

Straps 38, 39 can be formed of leather, PVC, synthetic leather rope or other appropriate material as desired. The buckle 40 is of known design and permits the entire gag unit 10 to be adjusted to the wearer's head size and shape. Other interconnectors such as a lock, tie, clasp or other mechanism can be substituted for the buckle 40 if desired.

I claim:

1. A novelty mouth gag providing unobstructed access to the wearer's mouth, the gag comprising, in combination,
a left bite block adapted to be inserted between and worn on the wearer's left molars, and, separately,
a right bite block adapted to be inserted between and worn on the wearer's right molars,
a left J-strap extending from the left bite block, the strap being sized and shaped to extend from the bite block out of the wearer's mouth, and latterly and rearwardly along the wearer's left cheek,
a right J-strap extending from the right bite block, the strap being sized and shaped to extend from the bite block out of the wearer's mouth, and latterly and rearwardly along the wearer's right cheek,
and a head strap arrangement adapted to extend from the left J-strap around the wearer's head to the right J-strap.

2. A novelty mouth gag providing unobstructed access to the wearer's mouth, the gag comprising, in combination,
a left bite block adapted to be inserted between and worn on the wearer's left molars, and, separately,
a right bite block adapted to be inserted between and worn on the wearer's right molars
and a head strap arrangement at least indirectly connected to the left and right bite blocks.

3. A novelty mouth gag according to claim 2 further including, respectively, a left J strap and a right J-strap, each strap being interconnected between a bite block and the head strap arrangement, each J-strap being sized, shaped and configured to urge the connected bite block rearwardly into the wearer's mouth as the head strap arrangement is secured and tightened around the rear of the wearer's head.
